(19) United States
(12) Patent Application Publication
(10) Pub. No.: US 2020/0019885 A1
(43) Pub. Date: Jan. 16, 2020

(54) Information Processing Apparatus and Information Processing Method

(71) Applicant: Hitachi, Ltd., Tokyo (JP)

(72) Inventors: Takashi TAKEMOTO, Tokyo (JP); Normann MERTIG, Tokyo (JP); Masato HAYASHI, Tokyo (JP)

(21) Appl. No.: 16/456,174

(22) Filed: Jun. 28, 2019

(30) Foreign Application Priority Data
Jul. 11, 2018 (JP) 2018-131464

(51) Int. Cl. G06N 20/00

(52) U.S. Cl. CPC G06N 20/00

(57) ABSTRACT

Provided is a more efficient method as a method of parameter adjustment of a graph embedded in an annealing machine. An information processing apparatus including an annealing calculation circuit including a plurality of spin units, which obtains a solution using an Ising model, is also provided. In the apparatus, each of the plurality of spin units includes a first memory cell that stores a value of the spin of the Ising model, a second memory cell that stores an interaction coefficient with an adjacent spin that interacts with the spins, a third memory cell that stores an external magnetic field coefficient of the spin, and an operational circuit that performs an operation of determining a next value of the spin based on a value of the adjacent spin, the interaction coefficient, and the external magnetic field coefficient. Further, the apparatus includes an external magnetic field coefficient update circuit that updates the external magnetic field coefficient with a monotonic increase or a monotonic decrease, and the annealing calculation circuit performs the annealing calculation a plurality of times by the operational circuit based on the updated external magnetic field coefficient.

### BACKGROUND OF THE INVENTION

### 1. Field of the Invention

The present invention relates to an information processing technique, and more particularly, to an information processing apparatus and an information processing method which adopt annealing as an algorithm for searching for an optimal solution.

### 2. Description of the Related Art

As an approach for solving a classification problem in the machine learning field, ensemble learning in which a final classification result is obtained by combining simple weak classifiers learned individually is known. The weak classifier is defined as a classifier that is slightly correlated with true classification. Compared to the weak classifier, a strong classifier is a classifier that is more correlated with the true classification. As the ensemble learning, a method which is boosting, bagging or the like is known. The ensemble learning can obtain reasonable accuracy at a high speed as compared to deep learning with high accuracy but high learning cost.

Meanwhile, annealing is known as a general algorithm for searching for an optimal solution. An annealing machine is a dedicated apparatus that executes annealing at a high speed and outputs an approximate optimal solution (see, for example, WO2015/132883 (Patent Literature 1), “NIPS 2009 Demonstration: Binary Classification using Hardware Implementation of Quantum Annealing” Hartmut Neven et. al., Dec. 7, 2009 (Non-Patent Literature 1), and “Deploying a quantum annealing processor to detect tree cover in aerial imagery of California” Edward Boyda et. al., PLOS ONE|DOI: 10. 1371/journal. pone. 0172505 Feb. 27, 2017 (Non-Patent Literature 2)). The annealing machine uses an Ising model as a calculation model capable of receiving a problem in general.

The annealing machine has a parameter of the Ising model as an input. Therefore, a user of the annealing machine needs to convert the problem to be solved into the Ising model.

In the ensemble learning, an evaluation function for obtaining a combination of the weak classifiers whose correct answer ratios are high and which are not similar to each other can be converted into the Ising model. In this regard, an example applied to the hardware of D-Wave Systems has been reported (see Non-Patent Literature 1 and Non-Patent Literature 2). These Non-Patent Literatures suggest that the annealing machine can derive a configuration of a strong classifier with excellent simplicity that has a small correlation with each other and is configured by a minimum required weak classifier.

As described above, the annealing machine has the Ising model as an input. However, when solving the classification problem by the annealing machine, a conversion step for converting a structure of a complete graph formulated into the Ising model into a simple and regular graph structure capable of being implemented in hardware is required.

As described in Patent Literature 1, the Ising model is generally represented by a following energy function H(s). Jᵢⱼ, hᵢ will be given as input to the annealing machine. In general, Jᵢⱼ is referred to as an interaction coefficient, and defines an influence from other spins (referred to as an adjacent spin) to its self-spin. Further, hᵢ is referred to as an external magnetic field coefficient. When these parameters are given, the machine executes the annealing and outputs an approximate solution of a spin array s at which energy is minimized.

$$H ( s ) = - {\sum }_{i < j}^{\# Spins} {J}_{i , j} {s}_{i} {s}_{j} - {\sum }_{i = 1}^{\# Spins} {h}_{i} {s}_{i} \qquad ( Formula 1 )$$

FIG. 1 is a conceptual diagram illustrating an overview of a Non-Patent Literature 1 and a problem thereof studied by the inventors.

In processing S101, a weak classifier dictionary is prepared. The weak classifier is learned as a weak classifier alone in a basic learning algorithm. It is an object of the following processing to select weak classifiers that complement each other from the prepared weak classifiers and constitute a highly accurate strong classifier with the selected weak classifiers.

In processing S102, the selection problem of the weak classifiers is formulated into an energy function of an Ising model. A solution can be obtained by the annealing machine by formulating the energy function of the Ising model.

In FIG. 1, H is an energy function, which is a solution obtained when it is the minimum. t is training data (feature quantity) and is included in a set T of the training data. A classification result (class) that is a correct answer is prepared for the training data. As the correct answer, for example, a result determined by a human is used.

In a first term on the right side, wᵢ is a weight that is the selection result of the i-th weak classifier, and wᵢ∈{0, +1} is satisfied. 0 shows non-selection, and +1 shows selection. N is the number of weak classifiers prepared. Cᵢ(t) is the classification result of the i-th weak classifier for the training data t. In addition, y(t) is a correct answer of the classification result of the training data t. The classification result is a classification label into two classes, which is (−1 or +1). Here, for example, the first term on the right side becomes 0 and takes a minimum value when only the classifier whose classification result is a correct answer is selected.

A second term on the right side is a regularization term and is introduced for redundancy avoidance and over-fitting prevention. Over-fitting on training data affects classification using following verification data. That is, the second term on the right side increases as the number of weak classifiers to be selected increases. Therefore, the second term on the right side functions as a penalty function. The weight of the penalty function can be adjusted to adjust the number of the weak classifiers to be selected by adjusting a value of λ. In general, the number of weak classifiers to be selected decreases as the value of λ increases.

By solving such a problem, an appropriate weak classifier can be selected from a set of prepared weak classifiers. After processing S103, the problem is processed by an annealing machine.

In graph embedding of processing S103, a complex graph structure of the formulated Ising model is converted into a simple and regular graph structure capable of being implemented in the hardware of the annealing machine. An algorithm for this purpose is well-known. Therefore, a description thereof will be omitted. As an example of the formulated Ising model, there is a complete combining graph (a state in which all vertices are connected) expressed by the formula in S102, for example.

Processings S101 to S103 described above are software-based processed by an information processing apparatus (host apparatus) such as a server.

In processing S104, the annealing calculation is performed by an annealing machine which is dedicated hardware. Specifically, an optimal solution is obtained by reading out the spin array s of the annealing machine when the energy state is minimized.

As an example of an annealing machine, for example, Patent Literature 1 discloses an example in which a plurality of spin units to which a semiconductor memory technique is applied is configured in a plurality of arrays. The spin unit includes a memory that stores information representing the spin, a memory that stores an interaction coefficient representing an interaction with other spins (adjacent spins), a memory that stores an external magnetic field coefficient, and an operational circuit that calculates the interaction and generates information representing the spin. An interaction calculation is performed in parallel by a plurality of spin units, and a ground state search is performed by transitioning a state of the spin to a state with small energy.

In order to perform the processing in the annealing machine, the graph structure converted in processing S103 is written as data from the host apparatus to a memory of the annealing machine. Thereafter, processing of annealing is performed to read out a spin sᵢ at a time of reaching the ground state to obtain a solution. The solution in the case of the selection problem of the weak classifier is a selection result wᵢ of the weak classifier, and is determined by the spin sᵢ.

A definition of the spin is free. However, for example, sᵢ=“+1 (or 1)” when the spin is upward, and sᵢ=“−1 (or 0)” when the spin is downward. When taking a value range of (1 or 0) for convenience of calculation as wᵢ showing a weight, the spin may be converted by sᵢ=2w₁−1. A configuration and operation of a specific annealing machine are well-known in Patent Literature 1, products of D-Wave Systems, and the like, and are thus omitted here.

In processing S105, the weak classifier is selected based on the solution obtained by the annealing machine to constitute a strong classifier. Usually, such a weak classifier and a strong classifier can be configured by software, and are performed by an information processing apparatus (host apparatus) outside the annealing machine. Verification data is input to the strong classifier to obtain a solution to verify the performance.

Here, c (vv) is a result of classifying the verification data v by the strong classifier, which is obtained as a majority decision of the classification result (−1 or +1) by N selected weak classifiers cᵢ. Further, err is a result of counting the number of erroneous classifications for the verification data v included in the set V. An err (v) takes two values of “0” or “1”, which is set to “0” when the classification result C(v) of the strong classifier matches a correct answer y(v), and is set to “1” when the classification result C(v) does not match the correct answer y(v).

On the basis of the classification accuracy err obtained in processing S105, the processing returns to processing S102 to adjust a necessary parameter and feed back the necessary parameter to processing S104. In the example of FIG. 1, the parameter to be adjusted is λ. Then, the parameter is optimized by repeating processing S104 and processing S105 until satisfactory strong classifier accuracy is obtained, for example, an err falling below a predetermined threshold.

In the above sequence, one of the practical problems is an increase in the processing time by repeating processing S104 and processing S105. As described above, in processing S104, the processing is performed by the annealing machine which is dedicated hardware. However, it is necessary to write and read out data from the host apparatus such as a server to the annealing machine each time the processing is performed, and processing takes time due to data transfer time.

A concept of graph embedding processing S103 will be described with reference to FIGS. 2A and 2B. As described above, in graph embedding, it is necessary to convert the complex graph structure of the Ising model into a graph structure capable of being implemented in the hardware of the annealing machine. Specifically, the graph structure of the Ising model has a structure logically converted from the problem to be solved. Meanwhile, in the hardware of the annealing machine, for example, the number of edges to one node, that is, the number of other nodes connected is fixed from the beginning. Therefore, it is necessary to convert into a graph structure capable of being implemented in hardware based on hardware constraint.

One of the conversion methods is a full graph embedding where all edges and nodes of the graph structure are stored and converted. In this method, although there is no loss of edges and nodes during conversion, it is necessary to make a plurality of spins correspond to one node of the graph structure among the spins implemented on the annealing machine. Therefore, when the number of spins implemented on the annealing machine is N, only the weak classifiers of √N+1 can be processed at the same time.

Meanwhile, in a one-to-one graph embedding in which the spin of the annealing machine and the node of the model correspond one-to-one, the same N classifiers as the number N of spins in the annealing machine can be processed at one time. Therefore, although the number of spins implemented on the annealing machine can be effectively utilized, a part of the edges of the original graph structure may be lost.

For example, in the technique described in Non-Patent Literature 1, in order to effectively utilize the number of spins, graph conversion is performed so as to ensure a number of vertices (nodes) of the graph before and after the conversion and preferentially leave an edge having a large weight, that is, an edge having a large correlation between weak classifiers. However, due to the disappearance of an edge with a small correlation, a spin having an external magnetic field coefficient that is always larger than a sum of combination coefficients, and a weak classifier that cannot be optimized is generated. The influence is greater as the number of spins increases.

An example shown in FIG. 2A will be described. In this example, a complete graph before graph embedding is embedded in a graph referred to as King's graph determined by hardware. In this case, edges J₁₄ and J₂₃ having small correlation before graph embedding disappear after graph embedding. Then, it is always assumed that the external magnetic field coefficient satisfies h₂>J₁₂+J₂₅+J₂₄ at a node 2. If the external magnetic field coefficient is always larger than the interaction of the adjacent spin, the optimization cannot be performed.

For example, in the annealing machine described in Patent Literature 1, a next state of the spin transitioning during the annealing is determined, and the next state of the spin is determined so as to minimize the energy between the spin units and the adjacent spins. This processing is equivalent to determining which of a positive value and a negative value is dominant when the products of the adjacent spin and the interaction coefficient Jᵢⱼ and the external magnetic field coefficient hᵢ are observed. However, the external magnetic field coefficient hᵢ becomes more dominant than the original model since a predetermined edge is lost due to graph embedding.

The influence will be described with reference to FIG. 2B. As can be seen in FIG. 2B, as the number of spins increases, a ratio of edges which is interaction coefficients Jᵢⱼ that can be embedded decreases. Therefore, as the number of spins increases, the accuracy is considered to decrease. A graph 2001 shows a limit value of embedding. A graph 2002 is a result of performing graph conversion by preferentially selecting an edge having a large weight by using the embedding algorithm described in Non-Patent Literature 1. A graph 2003 is a product of an average value of all weights and the number of edges, and is a case where a graph is mechanically converted. In any of the methods, it is understood that the interaction coefficient that can be embedded is 10% or less in a graph in which the number of spins (number of nodes) exceeds 100.

It is desirable to adjust parameters such as hᵢ and λ so as to obtain a reasonable result in the annealing calculation. However, in the related method shown in FIG. 1, in order to change the parameters such as hᵢ and λ, it is necessary to adjust the parameter based on the result of processing S105 in the host apparatus and repeat the annealing calculation. In this case, there is a problem that the processing takes time to write and read out data to and from the annealing machine. Therefore, a more efficient method is required as a method of parameter adjustment of a graph embedded in an annealing machine.

### SUMMARY OF THE INVENTION

A preferable aspect of the invention is to provide an information processing apparatus including an annealing calculation circuit including a plurality of spin units and obtaining a solution using an Ising model. In the apparatus, each of the plurality of spin units includes a first memory cell that stores a value of the spin of the Ising model, a second memory cell that stores an interaction coefficient with an adjacent spin that interacts with the spin, a third memory cell that stores an external magnetic field coefficient of the spin, and an operational circuit that performs an operation of determining a next value of the spins based on a value of the adjacent spin, the interaction coefficient, and the external magnetic field coefficient. Further, the information processing apparatus includes an external magnetic field coefficient update circuit that updates the external magnetic field coefficient with a monotonic increase or a monotonic decrease. The annealing calculation circuit performs the annealing calculation a plurality of times by the operational circuit based on the updated external magnetic field coefficient.

Another preferable aspect of the invention is to provide an information processing method using an information processing apparatus as a host apparatus and an annealing machine that performs an annealing calculation using an Ising model to obtain a solution. In this method, in the information processing apparatus, a weak classifier is generated, a classification result of the weak classifier is obtained from verification data, and a selection problem of the weak classifier at a time of constituting a strong classifier with the weak classifier is converted into an Ising model suitable for hardware of the annealing machine and sent to the annealing machine. Further, in the annealing machine, the external magnetic field coefficient and the interaction coefficient, which are parameters of the Ising model, are respectively stored in a memory cell. When the annealing calculation is performed a plurality of times, the external magnetic field coefficient is updated with a monotonic increase or a monotonic decrease, and then each annealing calculation is executed.

As a method of parameter adjustment of a graph embedded in an annealing machine, a more efficient method can be provided.

### BRIEF DESCRIPTION OF THE DRAWINGS

FIG. 1 is a conceptual diagram showing a problem of the invention;

FIG. 2A is a conceptual diagram showing a concept of graph embedding;

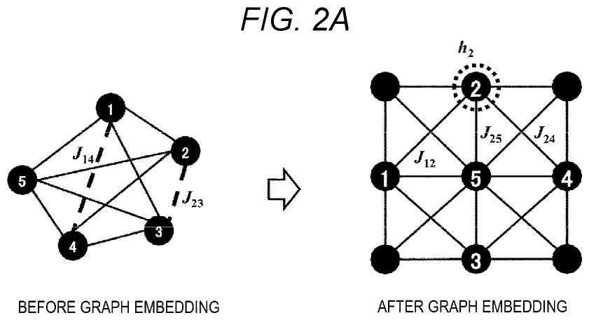

FIG. 2B is a graph showing a ratio of an interaction coefficient embedded in graph embedding;

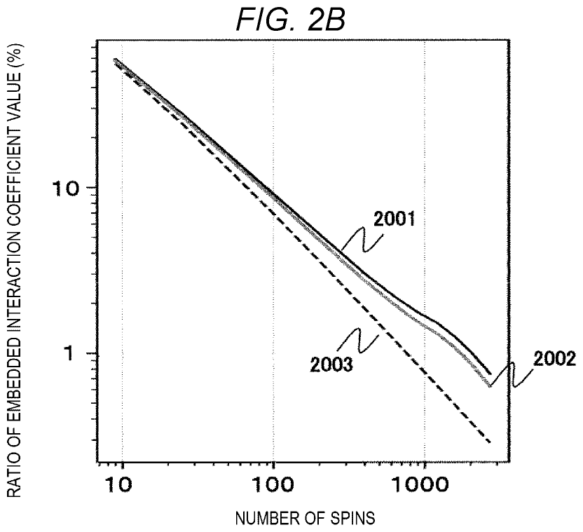

FIG. 3A is a block diagram showing an overall configuration of an information processing system according to an embodiment;

FIG. 3B is a circuit block diagram showing one spin unit of an annealing calculation circuit;

FIG. 4 is a flowchart showing an overall processing of the information processing system according to the embodiment;

FIGS. 5A and 5B are tables showing examples of classification result data;

FIG. 6 is a block diagram showing an example of a verification error calculation circuit;

FIG. 7 is a conceptual diagram showing a calculation example of a verification error calculation circuit;

FIG. 8 is a block diagram showing an overall configuration of an information processing system according to other embodiments;

FIG. 9 is a block diagram showing an example of an external magnetic field coefficient update circuit;

FIG. 10 is a flowchart showing an overall processing of the information processing system according to the embodiment using boosting;

FIG. 11 is a flowchart showing a part of the processing according to an embodiment incorporating a boosting method;

FIG. 12 is a conceptual diagram of a method for rationalizing verification error calculation in boosting;

FIG. 13 is a flowchart of verification error calculation performed by the verification error calculation circuit;

FIG. 14 is a conceptual diagram illustrating a view related to verification error of boosting;

FIG. 15 is an overall flowchart of an embodiment applied to full embedding;

FIG. 16A is a graph showing distribution of an interaction coefficient jᵢⱼ representing classifier correlation;

FIG. 16B is a graph showing a number of bits of the interaction coefficient jᵢⱼ on a horizontal axis and a number of allowable learning samples on a vertical axis; and

FIG. 16C is a schematic diagram showing a relationship between the interaction coefficient jᵢⱼ and an external magnetic field coefficient hᵢ for a certain spin.

### DESCRIPTION OF THE PREFERRED EMBODIMENTS

Embodiments will be described in detail with reference to the drawings. However, the invention should not be construed as being limited to the description of the embodiments described below. Those skilled in the art could have easily understood that specific configurations can be changed without departing from the spirit or gist of the invention.

In the configurations of the invention described below, the same or similar functions are denoted by the same reference numerals in common among the different drawings, and a repetitive description thereof may be omitted.

When there is a plurality of elements having same or similar functions, same reference numerals may be given with different subscripts. However, when there is no need to distinguish between the plurality of elements, the subscripts may be omitted.

The terms “first”, “second”, “third”, and the like in the present specification are used to identify the constituent elements, and do not necessarily limit the number, order, or the contents thereof. Also, the numbers for identification of the components may be used for each context, and the numbers used in one context may not necessarily indicate the same configuration in other contexts. In addition, the constituent elements identified by a certain number do not interfere with the function of the constituent elements identified by other numbers.

In order to facilitate understanding of the invention, a position, size, shape, range, or the like of each component illustrated in the drawings or the like may not represent an actual position, size, shape, range, or the like. Therefore, the invention is not necessarily limited to the position, size, shape, range, or the like disclosed in the drawings or the like.

The publications, patents, and patent applications cited herein constitute part of the description of the specification as it is.

Constituent elements in the specification represented in singular forms are intended to include the plural, unless the context clearly indicates otherwise.

### First Embodiment

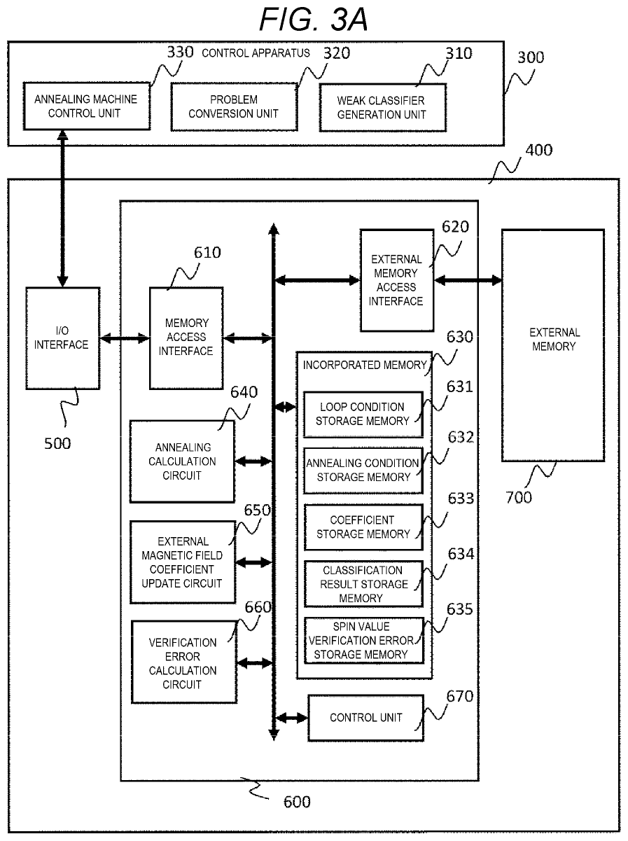

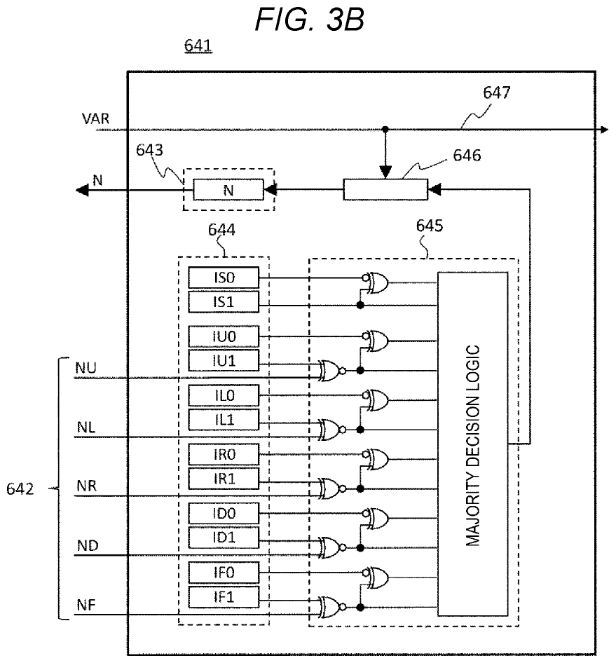

FIG. 3A is an overall block diagram of an information processing system according to an embodiment. A control apparatus 300 is, for example, a host apparatus such as a server. An annealing machine 600 is connected to the control apparatus 300 via an I/O interface 500. Further, the annealing machine 600 can also access an external memory 700. The I/O interface 500, the annealing machine 600, and the external memory 700 are respectively mounted on, for example, aboard 400 as a one-chip semiconductor apparatus. A plurality of annealing machines 600 and a plurality of external memories 700 may be mounted on the board 400.

The control apparatus 300 is configured by a general server, and the server includes a well-known configuration such as an input apparatus, an output apparatus, a processor, and a storage apparatus (not shown). In the embodiment, functions such as calculation and control of the control apparatus 300 are realized by executing a program stored in the storage apparatus by a processor in cooperation with other hardware. A program executed by a computer or the like, a function thereof, or a means that realize a function thereof may be referred to as a “function”, a “section”, a “portion”, a “unit”, a “module”, or the like.

In the control apparatus 300, a weak classifier generation unit 310 which constructs and learns a weak classifier, a problem conversion unit 320 which converts a selection problem of the weak classifier into ground state search of an Ising model and embeds a graph in hardware of an annealing machine, and an annealing machine control unit 330 which controls an annealing machine are implemented in software.

In the embodiment, it is considered that the configuration described in Patent Literature 1 is adopted as a part of the annealing machine 600. The annealing machine 600 is configured by, for example, a one-chip semiconductor apparatus, and includes a memory access interface 610, an external memory access interface 620, an built-in memory 630, an annealing calculation circuit 640, an external magnetic field coefficient update circuit 650, a verification error calculation circuit 660, and a control unit 670. The built-in memory 630 and the external memory 700 can be configured by a volatile or nonvolatile semiconductor memory such as a Static Random Access Memory (SRAM) or a flash memory.

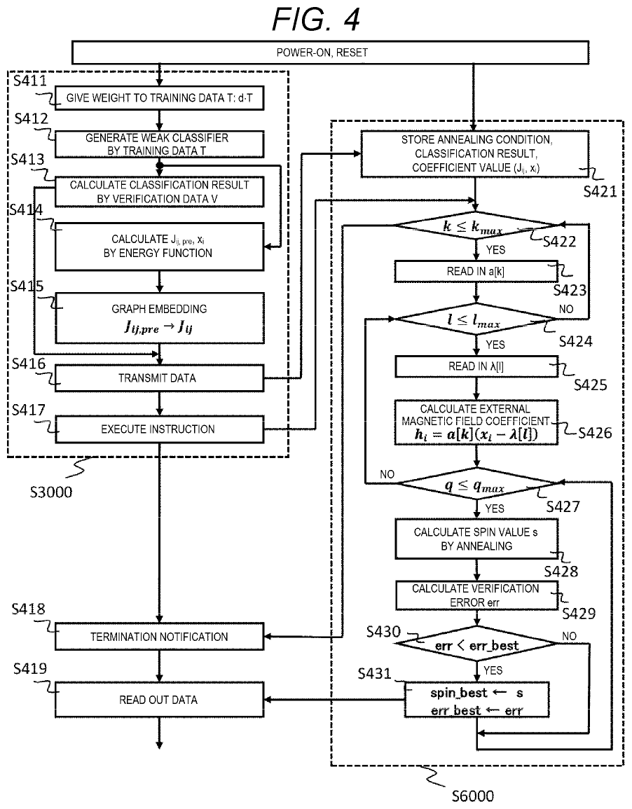

The memory access interface 610 enables the built-in memory 630 to be accessed from the control apparatus 300. The external memory access interface 620 enables the external memory 700 to be accessed from the annealing machine 600. The control unit 670 collectively controls an overall processing of each portion of the annealing machine 600 described later with reference to FIG. 4.

The built-in memory 630 stores data to be processed or data processed by the annealing machine 600. The built-in memory 630 includes a loop condition storage memory 631 which stores the loop condition for annealing, an annealing condition storage memory 632 which stores the annealing condition, a coefficient storage memory 633 which stores a coefficient value used for annealing calculation, a classification result storage memory 634 which stores a classification result of the weak classifier, and a spin value verification error storage memory 635 which stores a verification error of a spin value. Contents of the data will be described later.

The annealing calculation circuit 640 is, for example, a device capable of ground state search of the spin disclosed in Patent Literature 1. The external magnetic field coefficient update circuit 650 is a circuit performing an update of the external magnetic field coefficient used in the calculation of the annealing calculation circuit. The verification error calculation circuit 660 is a circuit that calculates a verification error of the weak classifier based on a calculation result of the annealing calculation circuit 640.

FIG. 3B is a circuit diagram showing a detailed configuration example of a spin unit constituting the annealing calculation circuit 640. In the embodiment, the annealing calculation circuit 640 arranges a plurality of spin units 641 configured by the semiconductor memory and a logic circuit disclosed in Patent Literature 1 to constitute a spin array, and performs a ground state search by performing parallel operation. The part not described in the specification may be followed by a well-known technique such as Patent Literature 1.

The spin unit 641 corresponds to one spin, and corresponds to one node of the Ising model. One spin unit 641 is connected to a spin unit of an adjacent spin by using NU, NL, NR, ND, and NF which are the interface 642, and inputs a value of the spin of the adjacent spin. Further, a value sᵢ of a self-spin is stored in a spin memory cell 643, and is output as an output N to the adjacent spin. In this example, one node has five edges.

The spin unit 641 includes a coefficient memory cell group 644 so as to hold the interaction coefficients J_{i,j} and the external magnetic field coefficient hᵢ of the Ising model. The coefficient memory cell is illustrated as IS0, IS1, which hold the external magnetic field coefficient hᵢ, and IU0, IU1, IL0, IL1, IR0, IR1, ID0, ID1, IF0, IF1, which hold the interaction coefficient In this example, IS0 and IS1, IU0 and IU1, IL0 and IL1, IR0 and IR1, ID0 and ID1, and IF0 and IF1 respectively play a role in a set of two, which, however, are not particularly limited. In the following description, they are collectively referred to as ISx, IUx, ILx, IRx, IDx, and IFx, respectively.

As an example of a structure of each memory cell included in the spin unit 641, a well-known SRAM memory cell can be used. However, a memory cell structure is not limited thereto as long as at least two values can be stored. For example, other memories such as a DRAM and a flash memory can be used.

Here, the spin unit 641 will be described as expressing the i-th spin sᵢ. The spin memory cell 643 is a memory cell that expresses the spin sᵢ, which holds a value of the spin. The value of spin is +1/−1 (is also expressed as +1 above and −1 below) in the Ising model, but corresponds to 1/0 which is a binary value inside the memory. In this example, although +1 is set to 1, −1 is set to 0, converse correspondence may be used.

ISx expresses an external magnetic field coefficient. Further, IUx, ILx, IRx, IDx, and IFx respectively express an interaction coefficient. IUx shows an upper spin (−1 in a Y-axis direction), ILx shows a left spin (−1 in an X-axis direction), IRx shows a right spin (+1 in the X-axis direction), IDx shows a lower spin (+1 in the Y-axis direction), and IFx shows an interaction coefficient with a spin (+1 or −1 in a Z-axis direction) connected in a depth direction.

The logic circuit 645 calculates a next state of a self-spin by performing energy calculation with the adjacent spins. In the embodiment, the value of the spin is inverted at a probability determined by a virtual temperature T. Here, a temperature T is an example of the processing of ground state search as physical annealing. At an initial stage of the ground state search, the temperature is high, then a local search is performed while gradually lowering the temperature, and the temperature is finally cooled to a state where the temperature becomes zero. The setting of the condition is stored in the annealing condition storage memory 632.

In order to invert the value of the spin at a predetermined probability, for example, a random number generator and a bit adjuster are used. The bit adjuster adjusts an output bit from the random number generator so as to invert the value of the spin at a high probability at an initial state of the ground state search and to invert the value of the spin at a low probability at an end stage. Specifically, the predetermined number of bits is taken out from the output of the random number generator, and is operated by a multiple-input AND circuit or an OR circuit to adjust the output such that many 1s are generated at the initial stage of the ground state search, and many 0s are generated at the end stage of the ground state search.

The bit adjuster output is VAR. The bit adjuster output VAR is input to an inverting logic circuit 646. An output of the logic circuit 645 outputs a value of the spin as a local solution. However, the value of the spin is inverted when the VAR is 1 in the inverting logic circuit 646. In this way, the value inverted at a predetermined probability is stored in the spin memory cell 643 that stores the value of the spin.

A line 647 is a configuration that shares a single random number generator and a bit adjuster with a plurality of spin units 641, which transfers the bit adjuster output VAR to an adjacent spin unit.

FIG. 4 is a diagram showing an overall flow of a processing by the information processing system in FIG. 3A. The left side of the flow is processing S3000 executed by the control apparatus 300. The right side of the flow is processing S6000 executed by the annealing machine 600.

First, processing on the control apparatus 300 side will be described. The processing of the control apparatus 300 is realized by a general server executing software.

In processing S411, the weak classifier generation unit 310 prepares training data T and gives a weight d to the data t respectively. An initial stage value of the weight may be uniform. The training data T is data to which a feature quantity and a correct answer of the classification for the feature quantity are given. In the specification, each training data to which the feature quantity and the correct answer of the classification for the feature quantity are given is denoted as t, and a set thereof is denoted as T. Processing S411 may be omitted and fixed as a uniform weight. A method of boosting using weighting will be described in the following embodiments.

In processing S412, the weak classifier generation unit 310 generates (learns) each weak classifier using the training data T. As the weak classifier, various well-known weak classifiers such as Stump (determination stump) can be used, with no particular limitation. Stump is a classifier that discriminates a value of a certain dimension of a feature vector by comparing it with a threshold θ, and is shown by fᵢ, θ(x)={+1, −1} in a simple example. If xᵢ, ≥θ, it is “+1”, and otherwise takes a value of “1”. Learning of each weak classifier is learning of θ.

In processing S413, the weak classifier generation unit 310 calculates a classification result of the weak classifier by verification data V. In the embodiment, the verification data V has data different from the training data T, but is data in which the correct answer as that of the training data is known.

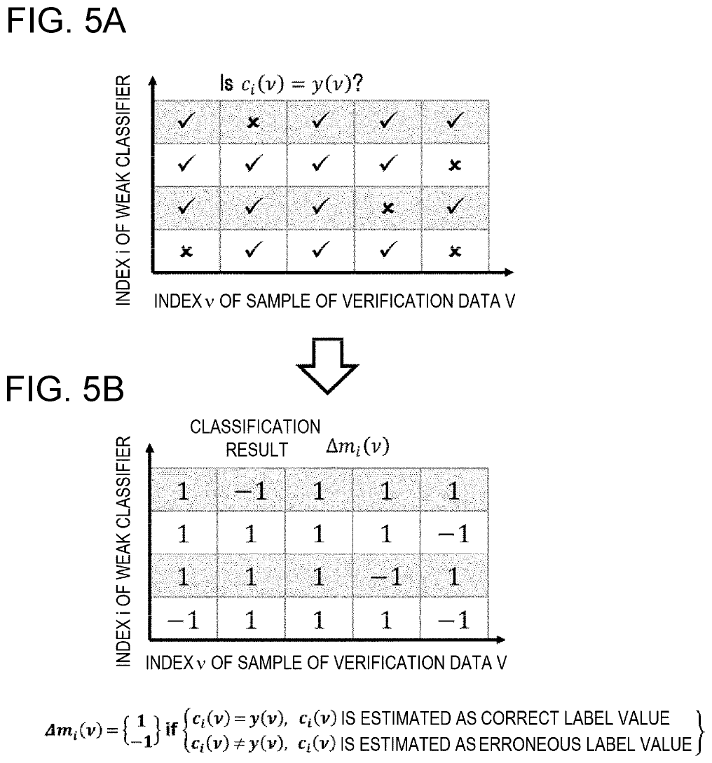

FIG. 5 is a table showing an example in which the classification result of the weak classifier is verified by the verification data V. In FIG. 5(a), a horizontal axis is an index v of a sample of the verification data V, and a vertical axis is an index i of the weak classifier. In the table, an intersection of v and i shows a result showing whether or not the corresponding verification data is correctly classified by the corresponding weak classifier. That is, whether or not the classification result cᵢ(v) of the weak classifier matches a correct answer y(v) is represented by a check mark when matching, or an x mark when not matching.

FIG. 5(b) is a diagram showing an example in which the verification result shown in FIG. 5(a) is converted into a function Δmᵢ(v) for storing the verification result as a classification result in the classification result storage memory 634 of the annealing machine 600. The horizontal axis is the index v of the sample of the verification data V, and the vertical axis is the index i of the weak classifier. Whether or not the classification result cᵢ(v) of the weak classifier matches the correct answer y(v) is stored, as a value of the function Δmᵢ(v), as a value of “1” when matching, or as a value of “−1” when not matching.

In processing S414, the problem conversion unit 320 determines interaction coefficients J_{ij,pri} and xᵢ by an energy function based on the learned weak classifier. When Stump is used as the weak classifier, parameters J_{ij,pri} and xᵢ of the Ising model are obtained depending on θ of a determination tree of the weak classifier. More specifically, the parameter of the Ising model is determined depending on the classification result of the training data of the weak classifier since Jᵢⱼ is a correlation between weak classifiers based on the classification result of training data, and hᵢ is determined by the classification accuracy of the training data of each weak classifier. However, the parameter depends on θ since the classification result depends on θ.

$$H ( s ) = - {\sum }_{i < j}^{\# Spins} {J}_{i , j} {s}_{i} {s}_{j} - {\sum }_{i = 1}^{\# Spins} {h}_{i} {s}_{i} \qquad ( Formula 2 )$$

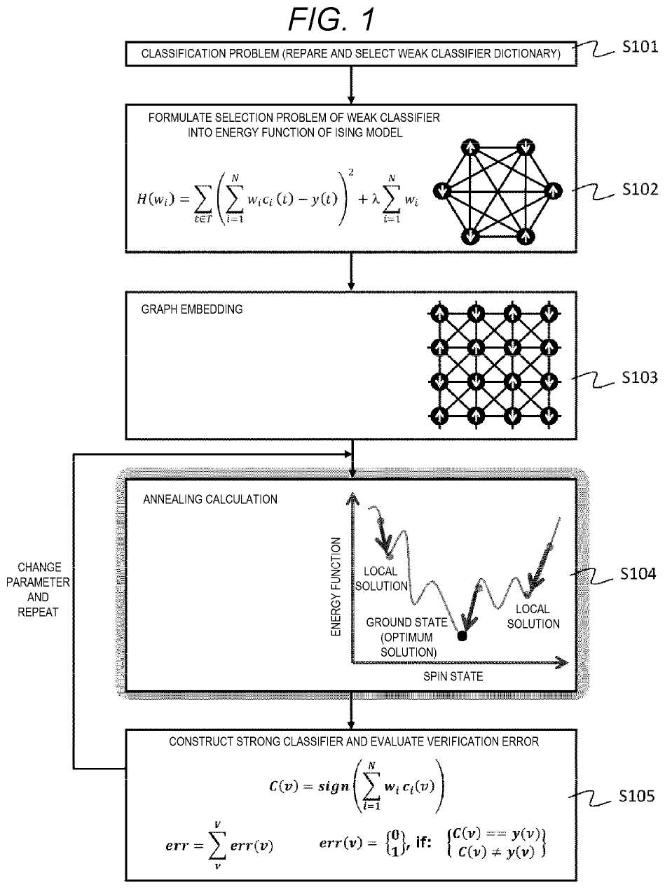

Above Formula 2 is a formula expressing an energy function H of a general Ising model. The Ising model can calculate the energy H(s) at that time from the given spin array, the interaction coefficient, and the external magnetic field coefficient. sᵢ and sⱼ respectively takes a value of “+1” or “−1” as a value of the i-th and j-th spin. In the relationship with the weight wᵢ in FIG. 1, sᵢ=2w₁−1 is satisfied. J_{i,j} represents an interaction coefficient between the i-th spin and the j-th spin, hᵢ represents an external magnetic field coefficient for the i-th spin, and s represents the spin array. In the Ising model according to the embodiment, the interaction from the i-th spin to the j-th spin and the interaction from the j-th spin to the i-th spin are not distinguished. That is, j_{i,j} and J_{j,i} are the same. An arrays of spins when H(s) is minimum can be obtained by using the Ising model as an input of an annealing machine and performing annealing.

$$H ( s ) = - {\sum }_{i < j}^{\# Spins} {J}_{i , j} pri {s}_{i} {s}_{j} - {\sum }_{i = 1}^{\# Spins} a ( {x}_{i} - λ ) {s}_{i} \\ {h}_{i} = a ( {x}_{i} - λ ) \qquad ( Formula 3 )$$

Above Formula 3 is an Ising model obtained by converting the determination tree of the weak classifier in the embodiment. Although basically the same as Formula 2, the external magnetic field coefficient hᵢ of the second term on the right side of Formula 2 is replaced with a (xᵢ−λ)sᵢ. That is, in the embodiment, in order to compensate for accuracy deterioration due to graph embedding, a parameter “a” for adjusting the external magnetic field coefficient hᵢ is introduced in addition to a regularization coefficient λ. J_{j,i}pri shows an interaction coefficient of the model before graph embedding.

In processing S414, the problem conversion unit 320 calculates the interaction coefficients J_{i,j}pri and xᵢ in Formula 3 by an energy function based on the prepared weak classifier.

$${J}_{ij} pri = - \frac{1}{2} {\sum }_{t ∈ T} {c}_{i} ( t ) {c}_{j} ( t ) \qquad ( Formula 4 )$$

In calculating Jᵢⱼpri (Formula 4), the right side to the left side Jᵢⱼpri functions to determine the correlation between weak classifiers, and not to simultaneously select weak classifiers having the same classification result for the same data. That is, when the classification result cᵢ(t) of the i-th weak classifier and the classification result cⱼ(t) of the j-th weak classifier are the same, Jᵢⱼpri becomes negative, and when both weak classifiers are selected, the first term on the right side of the first formula showing H(s) of Formula 3 increases, which thus functions as a penalty function. The parameter t is training data selected from a set of training data T.

$${x}_{i} = {\sum }_{t ∈ T} {c}_{i} ( t ) y ( t ) - \frac{1}{2} {\sum }_{j , t ∈ T} {c}_{i} ( t ) {c}_{j} ( t ) \qquad ( Formula 5 )$$

In Formula 5 calculating xᵢ, the right side determines the correlation between the weak classifier and the classification result, and selects a weak classifier having a high correct answer ratio. That is, the first term of the right side increases when the classification result cᵢ(t) of the i-th weak classifier and the correct answer y(t) are the same, and an absolute value of xᵢ increases. In the second term on the right side of Formula 3, the energy H(s) when the spin Sᵢ is −1 (non-selection) increases since xᵢ is negative, and the energy when the spin Sᵢ is +1 (selection) decreases, and thus functions as a penalty function at a time of incorrect answer. Further, the second term on the right side functions not to simultaneously select a weak classifier having similar results as in Formula 4.

In processing S415, the problem conversion unit 320 performs graph embedding so as to suit the energy function to the hardware of the annealing machine 600. As a result of graph embedding, the interaction coefficient J_{ij,pri} is converted to a hardware constrained interaction coefficient Jᵢⱼ. At this time, as described in Non-Patent Literature 1, the portion where the interaction coefficient Jᵢⱼ is heavy is preferentially embedded in the graph.

$$H ( s ) = - {\sum }_{( i , j ) ∈ ɛ}^{\# Spins} {J}_{i , j} pri {s}_{i} {s}_{j} - {\sum }_{i , j = 1}^{\# Spins} a ( {x}_{i} - λ ) {s}_{i} \\ {h}_{i} = a ( {x}_{i} - λ ) \qquad ( Formula 6 )$$

Formula 6 is an example in which one-to-one graph embedding is performed in the embodiment. In the first formula, H(s) on the left side is an energy function, and a combination of spins s at which H(s) is minimum is a solution. Conceptually, one spin corresponds to one weak classifier. i,j in the first term on the right side is an index representing a spin selected from a set of spins ε embedded in the annealing machine. Jᵢⱼ is an interaction coefficient from the i-th spin to the j-th spin, and is defined by Formula 4. The spin s shows selection of the weak classifier by “1”, and shows non-selection of the weak classifier by “−1”. The second term on the right side is a term for adjusting the external magnetic field coefficient hᵢ and the regularization coefficient λ by graph embedding.

In the second formula of Formula 6, the external magnetic field coefficient hᵢ on the left side is redefined. The external magnetic field is controlled such that the processing of graph embedding can be terminated at one time by introducing the parameter a. Here, hᵢ=a(xi−λ) is satisfied, λ is a regularization term, and a is a damping parameter.

In processing S416, the annealing machine control unit 330 transmits the Ising model embedded in the graph in processing S415 to the annealing machine 600. Further, the classification result Δmᵢ(v) obtained in processing S413 is transmitted to the annealing machine 600. Specifically, the data of the Ising model embedded in the graph is the interaction coefficient J_{i,j} and the parameter xᵢ of Formula 6. Although a and λ may be stored in the annealing machine from the beginning, a and λ may be transmitted from the control apparatus 300.

In processing S417, the annealing machine is instructed to execute annealing. Next, processing on the annealing machine 600 side will be described.

In processing S421, the annealing machine 600 that has received the data transmitted in processing S416 stores the interaction coefficient J_{i,j} and the parameter xᵢ as coefficient values in the coefficient storage memory 633. The interaction coefficients Jᵢ and the parameter xᵢ are stored corresponding to the index i, j of the spin. Further, the classification result Δmᵢ(v) shown in FIG. 5 is stored in the classification result storage memory 634. The annealing condition storage memory 632 stores a parameter T corresponding to a temperature at a time of performing annealing, and other parameters (for example, annealing number of times q). The parameter T can also be transmitted from the annealing machine control unit 330. The temperature parameter T and others at the time of performing the annealing are well-known together with the configuration of the annealing machine, and thus a description thereof will be omitted.

In the embodiment, once these pieces of data are sent from the control apparatus 300 to the annealing machine 600, it is not necessary to transmit and receive data to and from the annealing machine until a final solution is obtained. The parameters a and λ are stored in the loop condition storage memory 631 in a table format, for example, as the functions a(k) and λ(l) that define the loop condition. The loop condition may be transmitted from the control apparatus 300 as necessary. After processing S422, by changing the loop conditions a and λ, annealing is repeated while changing the external magnetic field coefficient hᵢ, and an optimum spin value is searched.

The annealing machine 600 sets a coefficient based on the Ising model. That is, the interaction coefficient Jᵢⱼ and the external magnetic field coefficient hᵢ of Formula 6 are set. Then, annealing is performed to search for a ground state. For example, as described above, in the hardware described in Patent Literature 1, the memory that sets the interaction coefficient J_{i,j} and the external magnetic field coefficient hᵢ for one spin is readable and writable by an SRAM compatible interface. Therefore, when the hardware is adopted as the annealing calculation circuit 640, the SRAM compatible interface is used as the memory access interface 610, and the interaction coefficient Jᵢⱼ and the external magnetic field coefficient hᵢ are set corresponding to each spin in the memory of the annealing calculation circuit 640.

In the embodiment, annealing is performed while changing a value of the external magnetic field coefficient hᵢ after processing S422, and more specifically, the optimum spin value is searched while changing the values of a(k) and λ(l). A range of the change in the value of the external magnetic field coefficient hᵢ takes the external magnetic field coefficient before embedding in the graph as a maximum value, and 0 as a minimum value. In the embodiment, a(k) and λ(l) will be described as monotonic increase functions. However, if various combinations of a(k) and λ(l) can be attempted, one or both of which may be monotonic decrease functions. The monotonic increase function is a function in which a value necessarily increases as k or l increases, and the monotonic decrease function is a function in which a value necessarily decreases as k or l increases.

First, in processing S423, a(k) is read in. k starts at 1 and is incremented to a maximum value kₘₐₓ in processing S422. When k exceeds the maximum value kₘₐₓ, the annealing is terminated (processing S422). In the embodiment, although the processing proceeds in a direction in which a(k) is increased from a minimum value, conversely, the processing may proceed in a direction in which a(k) is decreased from a maximum value. The maximum value of a(k) is determined to be, for example, twice the total number of weak classifiers.

Next, in processing S425, λ(l) is read in a(k) set in processing S423. l starts at 1 and is incremented to a maximum value lₘₐₓ in processing S424. When l exceeds the maximum value lₘₐₓ, a(k) is updated in processings S422 and S423. In the embodiment, although the processing proceeds in a direction in which λ(l) is increased from a minimum value, conversely, the processing may proceed in a direction in which λ(l) is decreased from a maximum value. When k exceeds kₘₐₓ in processing S422, a termination notification is sent to the control apparatus 300 (processing S418).

Although a (k) and λ(l) are stored in the loop condition storage memory 631 in a table format as described above, a(k) and λ(l) may be stored in a predetermined function format.

In processing S426, the external magnetic field coefficient update circuit 650 reads out xᵢ from the coefficient storage memory 633, and calculates the external magnetic field coefficient hᵢ based on the set a(k) and λ(l). The external magnetic field coefficient satisfies hᵢ=a(k)(xᵢ−λ(l)).

In processings S427 to S430, annealing is repeated qₘₐₓ times using the external magnetic field coefficient hᵢ obtained by the calculation of processing S426. In the circuit described in FIG. 3B, the external magnetic field coefficient hᵢ corresponding to each spin is stored in a memory cell of the coefficient memory cell group 644. Therefore, annealing is performed while updating the external magnetic field coefficient hᵢ of the memory cell.

In processing S428, the annealing calculation circuit 640 performs annealing, searches for a ground state, and obtains a spin array s in the ground state. A spin value sᵢ in Formula 6 shows a selection result (+1 or −1) of the weak classifier of an index i. The annealing is also well-known in Patent Literature 1 and Non-Patent Literatures 1 and 2, so that a description thereof will be omitted.

In processing S429, the verification error calculation circuit 660 calculates a verification error err using the selection result of the weak classifier obtained as a solution.

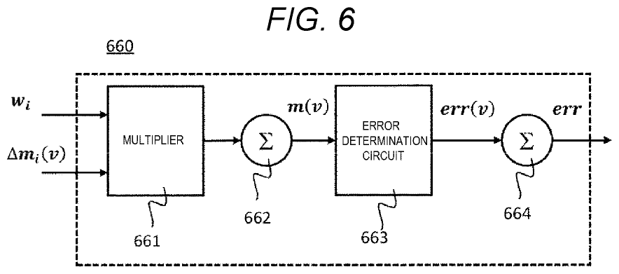

FIG. 6 is a block diagram showing a configuration example of the verification error calculation circuit 660. The verification error calculation circuit 660 calculates the verification error err using the spin array s in the ground state obtained by the annealing calculation circuit 640 and the classification result Δmᵢ(v) read out from the classification result storage memory 634. Here, it is assumed that the spin sᵢ={+1, −1} is converted into a weight wᵢ={1, 0} with sᵢ=2wᵢ−1. The weight “1” shows the selection of the classifier, and “0” shows the non-selection of the classifier.

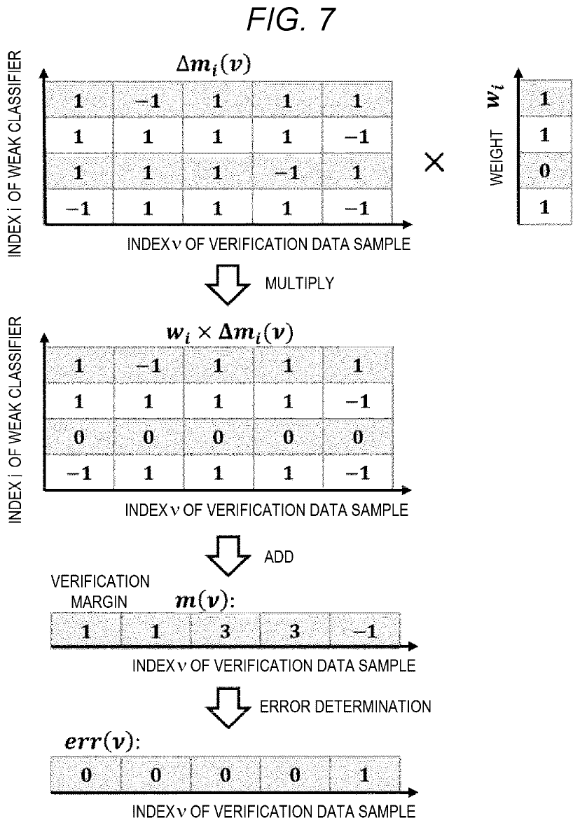

FIG. 7 is a conceptual diagram illustrating calculation performed by the verification error calculation circuit 660. First, a multiplier 661 multiplies the classification result Δmᵢ(v) by the weight wᵢ. As a result, a true or false determination of the selected weak classifier is totalized as a correct answer “+1” and an incorrect answer “−1”. The non-selected weak classifier is ignored as “0”.

A verification margin m(v) is obtained when the classification result is added by an adder 662 for each index of a verification data sample. The verification margin m(v) shows a totalization of the true or false determination of the classification result of the data v by the weak classifier. An error determination circuit 663 compares the verification margin m(v) with a predetermined threshold to perform an error determination. For example, when a simple majority decision is used as a reference, err(v)=1 (error exists for the data sample) is satisfied if the verification margin m(v) is negative as a threshold 0, and err(v)=0 (no error exists for the data sample) is satisfied if the verification margin m(v) is positive. An adder 664 totalizes the err(v) and obtains err. In the example in FIG. 7, err=1 (error exists) is satisfied.

As described above, the annealing machine 600 according to the embodiment can change the calculation condition of the annealing calculation circuit 640 by changing the parameter that does not influence graph embedding processing. Further, the error determination can be performed using the weight wᵢ which is the calculation result of the annealing calculation circuit 640 and the classification result storage memory 634, since the classification result storage memory 634 stores the classification result Δmᵢ(v) of the weak classifier. Therefore, it is possible to obtain a solution based on an optimum parameter only in the annealing machine 600.

The annealing machine usually performs a plurality of times (qₘₐₓ times in the example of FIG. 4) of annealing since annealing is a calculation based on probabilistic behavior. In processing S428, the ground state is searched using the function of the annealing machine, and the value of the spin in the ground state is calculated.

In processing S430, the error value err is compared with err_best, which is a best value (a minimum error value) so far. If the value of the latest error is smaller than the best value so far, the spin array s and the error value err at that time are set as spin_best and err_best in processing S431, stored in the spin value verification error storage memory 635, and an optimum value is updated in the loop.

When k exceeds kₘₐₓ in processing S422, a termination notification is sent from the annealing machine 600 to the control apparatus 300 in processing S418. Then, the values of the spin_best, err_best are readout from the spin value verification error storage memory 635 in accordance with the data read out instruction of processing S419 and transmitted to the control apparatus 300. This becomes a combination of optimal weak classifiers calculated in the annealing machine 600.

According to the embodiment, in the first formula showing H(s) of Formula 6, the annealing condition can be changed in a part (i.e., the second term on the right side) other than the first term on the right side including Jᵢⱼ depending on graph embedding. Thus, after graph embedding, the annealing condition can be changed in the annealing machine 600. Further, the classification result of the verification data is transferred to the annealing machine 600, which can be used to perform the determination of the result in the annealing machine 600. According to this, the change of the annealing condition and the determination of the result can be completed in the annealing machine 600.

Therefore, for example, when the annealing machine described in Patent Literature 1 is configured by a Field-Programmable Gate Array (FPGA), a combination result (that is, the selection result of the weak classifier) of the optimal spin obtained in the FPGA may be transmitted only once to the control apparatus 300, so that the time for reading out data and transferring data can be saved.

### Second Embodiment

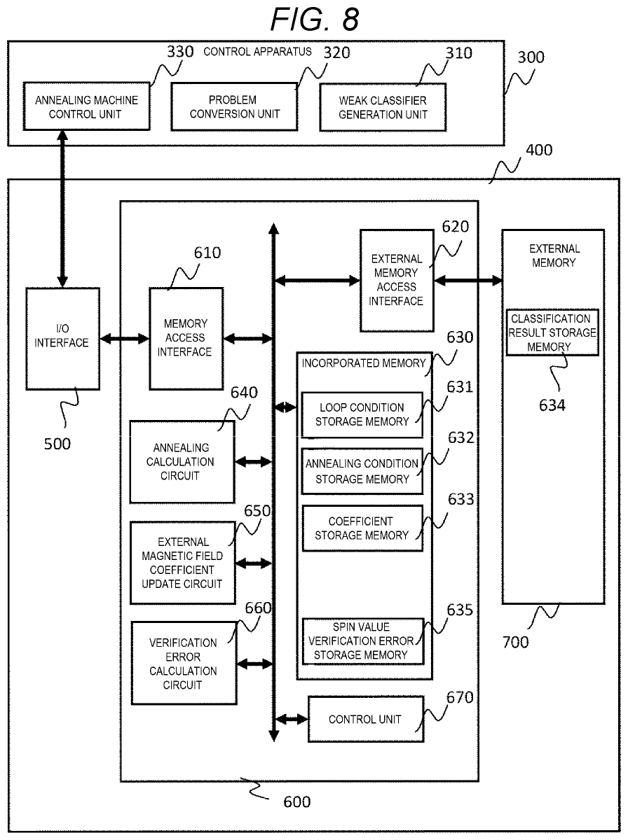

FIG. 8 is an overall block diagram of an information processing system according to a second embodiment. In the first embodiment, a part of the built-in memory 630 of the annealing machine 600 is used as the classification result storage memory 634. The built-in memory 630 is a built-in memory of the annealing machine 600 configured by one chip such as an FPGA, and is a high speed memory such as an SRAM. However, when the classification result is large in data capacity according to the scale of verification data, instead of the built-in memory 630, a part of the external memory 700 may be used as the classification result storage memory 634. For example, in the case of an external memory configured by a separate chip mounted on the same board, high speed reading out can be performed as compared to reading out from the control apparatus 300.

Further, the external memory 700 may substitute the annealing condition storage memory 632 or the spin value verification error storage memory 635 in some cases. Meanwhile, the loop condition storage memory 631 and the coefficient storage memory 633 that store a variable for calculating the external magnetic field coefficient hᵢ are desirably read out at a high speed, and therefore, it is desirable to use the built-in memory 630. The external memory 700 can easily increase its capacity as compared with the built-in memory 630. Therefore, other data such as values of all spins may be stored for debugging.

Further, when the classification result is stored in the external memory 700, the calculation of the verification error of a previous annealing result may be implemented in parallel during the annealing calculation, so that the influence of the delay generated by the data transfer between the external memory 700 and the annealing machine 600 can be reduced overall.

### Third Embodiment

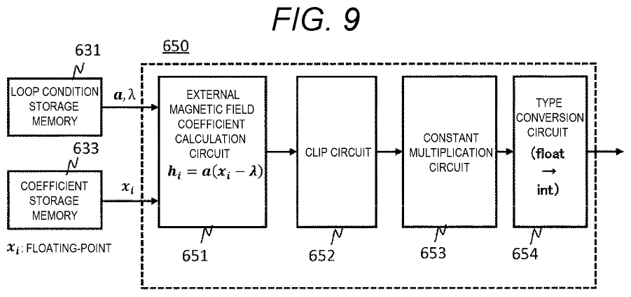

FIG. 9 is a detailed block diagram showing an example of the external magnetic field coefficient update circuit 650 shown in FIGS. 3 and 8. A third embodiment shows a preferred specific example of the external magnetic field coefficient update circuit 650.

It is desirable to calculate the external magnetic field coefficient hᵢ with accuracy as high as possible. Meanwhile, the capacity of the memory for the external magnetic field coefficient hᵢ that can be implemented in the annealing machine 600 is limited. Therefore, for the calculation of the external magnetic field coefficient hᵢ, the data a, λ, and xᵢ performing a floating-point operation using floating-point data and then performing annealing calculation by the external magnetic field coefficient hᵢ converted to integer data are calculated by the host apparatus (server), and thus are transmitted as floating-point data. The external magnetic field coefficient calculation circuit 651 of the external magnetic field coefficient update circuit 650 reads out floating-point data a, λ, and xᵢ from the loop condition storage memory 631 and the coefficient storage memory 633, and calculates hᵢ with high accuracy.

A clip circuit 652 clips the calculation result hᵢ in a range that does not influence the annealing calculation to limit a value range. That is, as described above, for example, in the annealing machine described in Patent Literature 1, a next state of the spin is determined by determining which of the positive value and the negative value is dominant when the product of the adjacent spin and the interaction coefficient Jᵢⱼ and the external magnetic field coefficient hᵢ are observed. Therefore, in this example, even if a larger value is given as the external magnetic field coefficient hᵢ than the number of adjacent spins (that is, the number of edges), the result remains unchanged. For example, when a resolution of the coefficient hᵢ is 10 bits, a graph structure of the annealing machine is 8 edges per spin and J_{i,j}∈{−1, 1} is satisfied, even if the coefficient hᵢ is clipped at +8 to −8, a data volume can be reduced while compensating for the problem of accuracy deterioration.

Therefore, in the clip circuit 652, the coefficient hᵢ is clipped at +8 to −8. The clipped coefficient is multiplied by 64 times by a constant multiplication circuit 653, and is set to an integer value by a type conversion circuit 654 when the resolution required for the annealing calculation is set to 10 bits. As a result, the annealing calculation can be implemented at integer values +511 to −511 corresponding to 10 bits required for the annealing calculation. Calculation can be performed with necessary accuracy while saving a memory volume by performing the type conversion of the data in this way.

### Fourth Embodiment

In the first embodiment, an embodiment capable of applying to ensemble learning in general using a weak classifier has been described. In the fourth embodiment, an example in which a boosting method is adopted in the ensemble learning will be described.

As is well-known, AdaBoost or the like is known as an algorithm of the ensemble learning in which a weak learner is constructed sequentially. AdaBoost is a method that feeds a classifier error back based on the classifier error to create an adjusted next classifier. For the training data T, the weak classifier is applied in an order from t=1 to t=tₘₐₓ (tₘₐₓ is the number of samples of (set of) the training data T), and it is determined whether or not each training data T is correct. At this time, the adjustment is performed while the weight for the erroneously classified sample is adjusted to be heavy or, conversely, the weight for the sample that has been correctly answered is reduced.

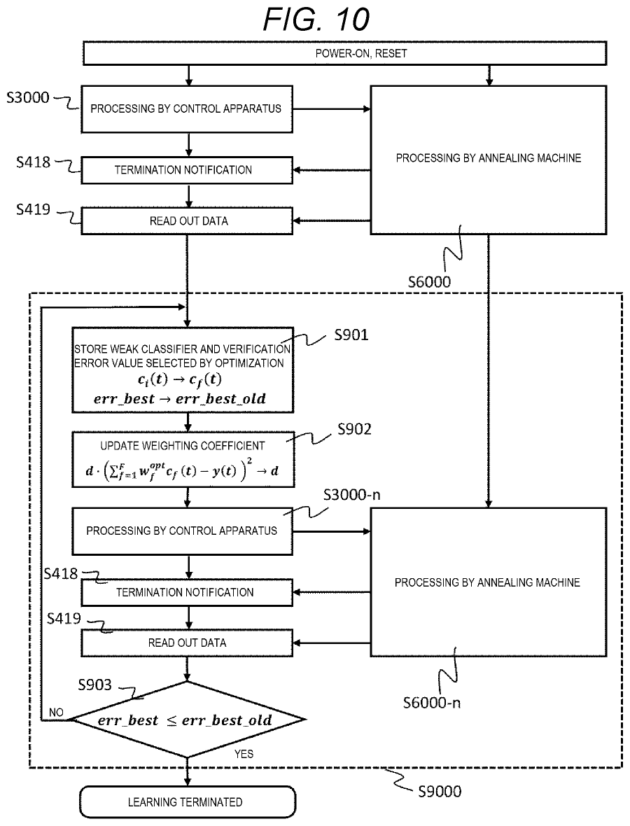

FIG. 10 is a diagram showing an overall flow of processing by the information processing system according to the embodiment that adopts a boosting method. The boosting processing S9000 is added to the flow shown in FIG. 4, and the same processing as those shown in FIG. 4 are denoted by the same reference numerals, and the description thereof is omitted. Although processing S3000-n by the control apparatus and processing S6000-n by the annealing machine in processing S9000 are basically the same as processing S3000 and S6000 described above, differences will be mainly described below.

After power on and reset, the same processing as the flow in FIG. 4 is performed, and the control apparatus 300 reads out data as a result of annealing (optimization) in processing S419.

In processing S901, the weak classifier generation unit 310 of the control apparatus 300 stores the weak classifier cᵢ and the verification error value err selected by the optimization by the annealing machine 600. Next, the weak classifier generation unit 310 of the control apparatus 300 obtains a classification result cᵢ(t) for the training data T for the selected weak classifier cᵢ, and substitutes it to a variable c_{f}(t). Further, err_best is substituted to a variable err_best old.

The weak classifier generation unit 310 updates a weighting coefficient d of the training data t in processing S902. An initial value of the weighting coefficient d may be normalized such that an overall sum becomes 1 at d=1/tₘₐₓ when the number of training data samples is tₘₐₓ.

In the example of FIG. 10, in processing S902, y(t) is a correct answer to the classification result of the training data t, and w_{f}^{opt} is a weight w_{f}^{opt}∈{0, +1} of the weak classifier optimized in processing S6000. In Σ, only a number F of the weak classifier is added. The weight d for the training data t having a large number of incorrect answers becomes heavy since c_{f}(t)−y(t) becomes 0 in the case of correct answer. In processing S411-n in the next processing S3000-n by processing S902, the weighting coefficient d that is uniform in processing S411 in processing S3000 in FIG. 4 is updated.

After the update of the weighting coefficient d, processing S3000-n by the control apparatus 300 and processing S6000-n by the annealing machine 600 are performed again in the same manner as processing S3000 and processing S6000 in FIG. 4. At this time, the weighting coefficient d for the erroneous training data t is updated so as to be heavy. In processing S3000-n by the control apparatus 300, the weak classifier is learned in the same manner as processing S412, using the weighted updated training data T.

In boosting, a selection problem of a weak classifier obtained in the past and a newly obtained weak classifier is set in an annealing machine. Therefore, in processings S414-n to S415-n in processing S3000-n in FIG. 10, graph embedding is performed on the weak classifier obtained in the past and the newly obtained weak classifier.

In processing S6000-n, contents of the memory storing the external magnetic field coefficient, the interaction coefficient, and the spin are updated based on the embedded graph. Then, the problem is solved by the annealing machine 600, and a new err_best obtained in the result processing S431 is compared with a variable err_best old. When the excellent err_best old is obtained, the learning is terminated in processing S903. When the result is not obtained, while storing the result in processing S901, the weighting coefficient is updated in processing S902, and processing S3000-n and processing S6000-n are repeated.

The boosting processing S9000 may be repeated any number of times. According to study, the number of weak classifiers increases and the verification error decreases by repeating optimization by boosting. However, if the number of weak classifiers increases to a certain degree or more, the verification error turns to increase. Therefore, an increase tendency of the verification error may be detected to determine the termination of the boosting processing. According to the above example, a weak classifier that compensates for a weak point of a previous weak classifier is generated and selected by the boosting processing S9000.

In the above processing, when a total amount of the number of weak classifiers selected in the past optimization and the number of newly obtained weak classifiers is smaller than the number of spins mounted in the annealing machine, they can be collectively processed. When the total amount of weak classifiers exceeds the number of spins, for example, a method may be considered that the weak classifiers selected so far are pooled, annealing is performed only by the newly generated weak classifiers (whose number is equal to or smaller than the number of spins), the verification error evaluation is performed with err of the optimized classifier+pooled err of the previous weak classifiers.

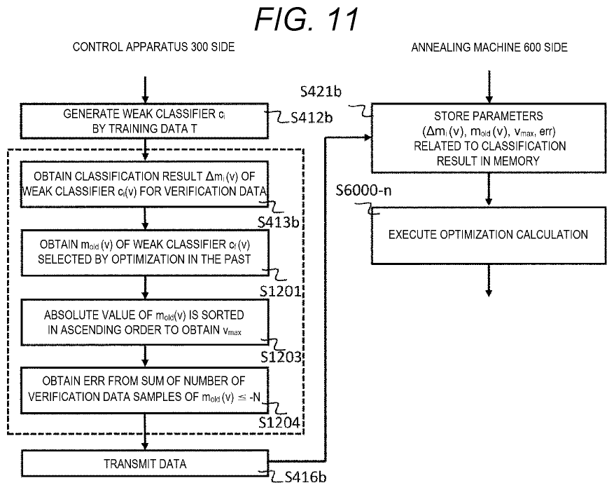

FIG. 11 is a flowchart of a processing to be added after the weak classifier generation processing S412 of processing S3000-n in FIG. 10. It is assumed that the weak classifier generation unit 310 executes on the control apparatus 300 side. In FIG. 11, the weak classifier generation processing S412 is generated by the training data in which the weighting d is changed, and thus is denoted as a processing S412b.

In processing S412b, a weak classifier cᵢ(v) is generated with the training data T in which the weighting is changed.

In processing S413b, a classification result Δmᵢ(v) is obtained by the verification data V for the weak classifier cᵢ (v) generated in processing S412b. This processing is performed in the same manner as processing S413 in FIG. 4 described in FIG. 5.

In processing S1201, a verification margin m_{old} (v) of the weak classifier c_{f}(t) selected by optimization S6000 in the past is obtained. If optimizations are performed two times or more in the past, all of the results are obtained. A method of obtaining the m_{old}(v) is the same as the processing of obtaining m(v) of the verification error calculation circuit 660 of the annealing machine 600 described in FIG. 7. Therefore, the control apparatus 300 has a function of performing processing equivalent to that of the verification error calculation circuit 660. The weight wᵢ of the weak classifier c_{f}(t) selected for processing is acquired from the annealing machine 600 when processing S431 is performed. Alternatively, the verification margin m(v) calculated by the annealing machine 600 may be separately transmitted and stored as a m_{old}(v).

In processing S1203, an absolute value of the m_{old} (V) is sorted in an ascending order, and vₘₐₓ, which is an index of a maximum m_{old} (v) after sorting and in which the absolute value of the verification margin m_{old}(v) becomes smaller than the number of spins N, is obtained. Thus, vₘₐₓ is equal to the number of verification data in which the absolute value of m_{old}(v) is smaller than the number of spins N. The necessary memory volume to store the m_{old}(v) is unknown at a time of design since the boosting processing may also increase the absolute value of the verification margin as it increases the weak classifier. However, by implementing the processing, the necessary memory volume can be estimated at the time of design since the maximum number of verification margins is limited to equal to or smaller than N. Further, as for the m_{old} (v) having an absolute value equal to or greater than N, it is not necessary to calculate the mold since the result of the error is known in advance by processing S1204.

In processing S1204, err is obtained from the sum of samples of the verification data of m_{old}(v)≤−N. The verification data extracted under the above condition does not change the result (err=1) that it is an error regardless of the result of the next optimization. Therefore, the calculation volume can be reduced by processing as an error in advance.

In processing S416b, the data is transmitted to the annealing machine 600.

On the annealing machine 600 side, parameters Δmᵢ(v), m_{old}(v), vₘₐₓ, err related to the classification result in processing S421b are stored in the classification result storage memory 634. After that, the optimization calculation processing S6000-n is executed.

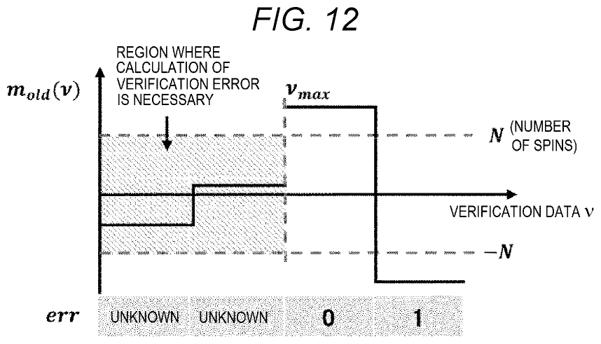

FIG. 12 is a conceptual diagram of a method of rationalizing verification error calculation in boosting. A horizontal axis shows an index v of the verification data V, and a vertical axis shows the verification margin m_{old}(v) of the weak classifier selected in the past. when the m_{old}(v) is equal to or greater than the number of spins N, even if all weak classifiers are selected in the next optimization calculation and the classification result thereof is an incorrect answer, the error determination is considered without problem with no error (err=0) and no further calculation of the verification error is necessary since the result of the verification error due to the majority decision is not changed. Further, when the m_{old}(v) is equal to or smaller than −N, even if all weak classifiers are selected in the next optimization calculation and the classification result thereof is a correct answer, it is considered that no further calculation of the verification error is necessary since the result of the error determination (err=1) is not changed. In this case, a region where the calculation of the verification error is necessary is considered to be a hatched part in FIG. 12.

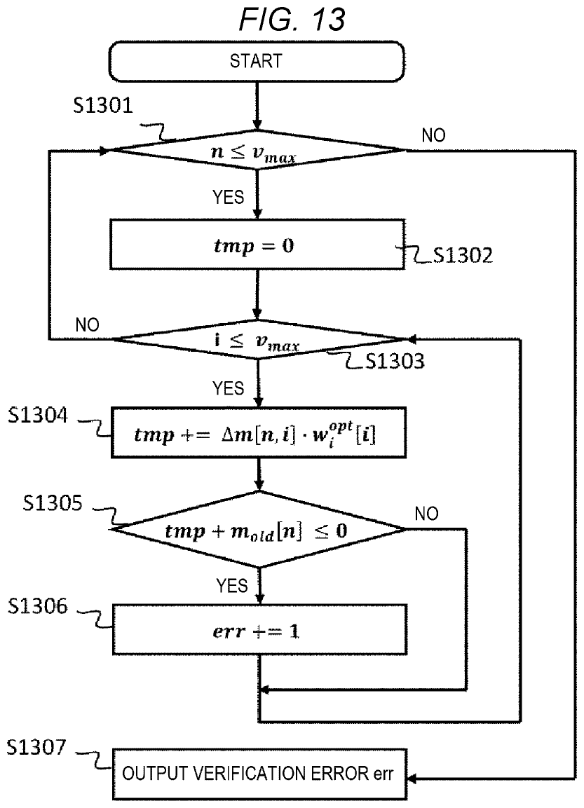

FIG. 13 is a flowchart of the verification error calculation S429 performed by the verification error calculation circuit 660. In this flow, an order of the verification data V sorted in processing S1203 is substituted into a loop parameter “n”.

In processing S1301, an index n of the verification data sample is compared with vₘₐₓ. vₘₐₓ is equal to the number of samples whose absolute value of the verification margin is equal to or smaller than N.

In processing S1302, a variable tmp is set to an initial value 0 when the index n is smaller than vₘₐₓ. The variable tmp is used to calculate a verification margin for each verification data sample n.

In processing S1303, an index i of the weak classifier is compared with the number of spins N. That is, in the processing in FIG. 13, even if the number of weak classifiers selected in the past is large, it is assumed that up to N weak classifiers are processed.

In processing S1304, Δm[n, i]·wᵢ^{opt}[i] is added to the variable tmp when the index i is equal to or smaller than N. This corresponds to the calculation processing of the verification margin in FIG. 7.

In processing S1305, it is determined whether or not the variable tmp+m_{old}[n]≤0 is satisfied. This is a processing of determining whether or not there is an error in which the verification margin tmp by a current optimization and the verification margin m_{old}[n] by the optimization in the past are combined. If the verification margin is equal to or smaller than 0, in processing S1306, if tmp+m_{old} [n]≤0 is satisfied in processing S1305, “1” is added to err, and the err value is incremented until the loop processing is terminated.

If tmp+m_{old}[n]≤0 is not satisfied in processing S1305, the processing returns to processing S1303 to increment i. If the index i is greater than N in processing S1303, the processing returns to processing S1301 to increment the index n of the verification data.

The loop processing in S1303 to S1305 in the second half adds the verification result of the weak classifier i to the number of spins N to the verification data n, and calculates a verification margin (variable tmp).

An example of the calculation of the verification error is given by Formula 7.

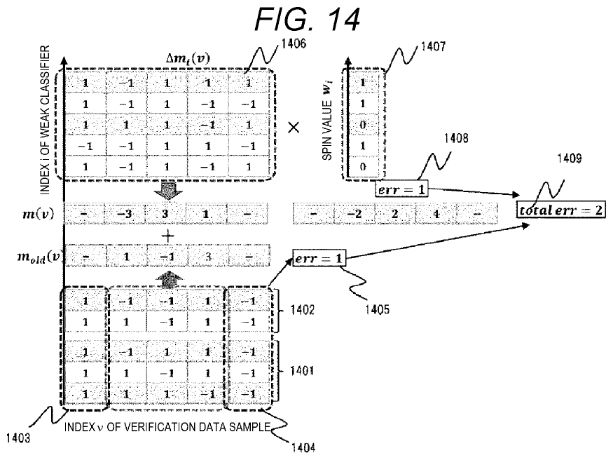

FIG. 14 is a conceptual diagram showing a view related to verification error calculation of boosting shown in FIGS. 11 to 13. Here, it is assumed that five spins are implemented for simplification, and optimization is performed two times in the past, and this is processing performed after a third time optimization calculation.

In FIG. 14, data 1401 is a classification result of the weak classifier selected in a first time optimization, and data 1402 is a classification result of the weak classifier selected in a second time optimization. In processing S1201 in FIG. 11, the control apparatus 300 obtains the m_{old}(v) from the data 1401 and 1402, and sends the m_{old}(V) to the annealing machine 600 in processing S416b. At this time, the verification data sample of the data 1403 and 1404 having an absolute value of the verification margin m_{old} (v) equal to or greater than the number of spins N (5 in this example) can be excluded from subsequent calculation. This is due to that a result of the majority decision is not changed by the weak classifier newly selected for the third time by the optimization when the verification margin of the weak classifier selected by the optimization in the past is equal to or larger than the number of spins (=the number of weak classifiers to be optimized).

Further, for the verification data samples of the data 1404 in which the absolute value of the verification margin m_{old}(v) is equal to or greater than the number of spins N and is a negative value, an error has already been determined regardless of the third time optimization calculation result. Therefore, the number is counted as “err=1” in processing S1204. This value is also sent to the annealing machine 600 in processing S416b.

Meanwhile, the data 1406 is the classification result Δmᵢ (v) of the weak classifier newly created in processing S412b, which is calculated in processing S413b and sent to the annealing machine 600 in processing S416b.

On the annealing machine 600 side, optimization of the newly created weak classifier is performed, and a spin value 1407 which is a selection result is obtained. As in FIG. 7, a verification margin m(v) is obtained from the classification result Δmᵢ (v) and the spin value wᵢ. Then, an error value 1408 is obtained by adding a meaningful part (absolute value of the verification margin is smaller than N) among the verification margin m_{old} (v) obtained from the optimization result in the past. A final error value 1409 is obtained by adding the error value 1408 and the determined error value 1405.

$$\underline{verification margin for verification data v \text{:}} \\ m ( v ) = {m}_{old} ( v ) + {\sum }_{i = 1}^{N / \# Spin} {w}_{i} Δ {m}_{i} ( v ) \\ \underline{margin by previous boosting step \text{:}} \\ {m}_{old} ( v ) = {\sum }_{f = 1}^{F} Δ {m}_{f} ( v ) \\ \underline{error value for sample v \text{:}} \\ err ( v ) = \{ \begin{matrix}1 & if m ( v ) \leq 0 \\ 0 & else\end{matrix} \} \\ \underline{verification error value \text{:}} \\ err = {\sum }_{v}^{V} err ( v ) \qquad ( Formula 7 )$$

### Fifth Embodiment

In the embodiments described above, although a one-to-one graph embedding is performed on the annealing machine, a full graph embedding may be performed. When the full graph embedding is performed, a damping parameter a can be fixed. Although the full graph embedding cannot fully utilize the hardware (number of nodes) of the annealing machine, it is not necessary to change the parameter a. In this case, in the flow in FIG. 4, the change of the parameter a may be omitted, and it is sufficient to change only λ. By changing λ, the external magnetic field hᵢ is adjusted.

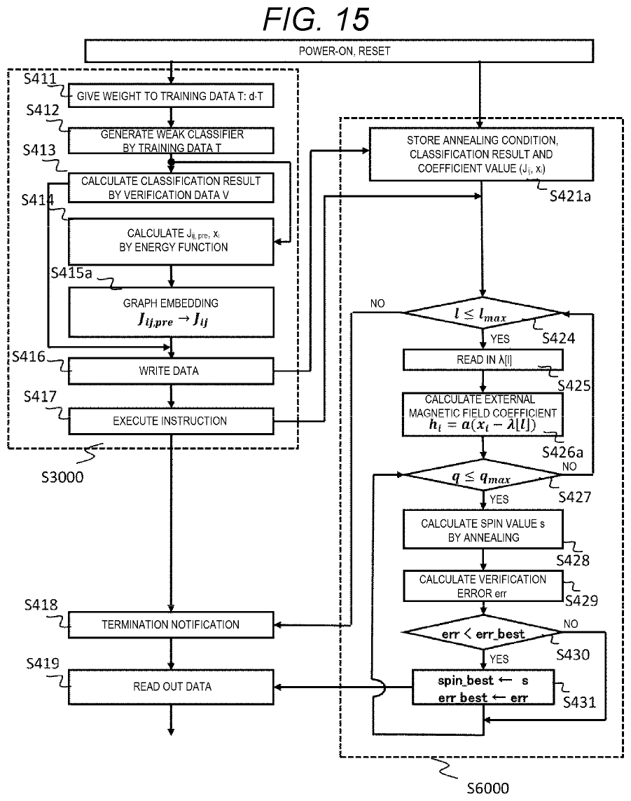

FIG. 15 is an overall flowchart of the embodiment. As shown as a modification of the first embodiment, the same components as those in the flow in FIG. 4 are denoted by the same reference numerals, and thus the description thereof will be omitted. As a difference, in processing S415a, a full graph embedding is performed. As the annealing condition, the parameter a is set as a constant value (constant) and is stored in the annealing condition storage memory 632 in processing S421a. The loop that changes the parameter a disappears as compared with the flow in FIG. 4, and in processing S426a calculating the external magnetic field coefficient, a is set as a constant, and hᵢ=a(xᵢ−λ(l)) is calculated.

### Sixth Embodiment

As a modification of the first embodiment, an example in which the processing can be performed at a high speed is shown. When the relationship of the following Formula 8 related to all spins sᵢ (i=1, . . . N) is satisfied, the spin cannot be optimized in the first place. That is, the value of the self-spin is fixed regardless of the value of the adjacent spin. Therefore, it is not necessary to perform the annealing calculation.

$${h}_{i} > {\sum }_{j = 1}^{N - 1} {J}_{ij} \qquad ( Formula 8 )$$

Therefore, the number of times of the loop processing can be reduced, and the processing speed can be increased by checking a parameter space satisfying the above relationship in advance. Further, a region in which the number of spins satisfying the above relationship is relatively large is assumed to be a region that is not so important in finding an optimal solution of an overall solution space. Therefore, with regard to this region, it is possible to increase the speed by roughening the number of times of annealing and a temperature schedule of annealing.

In the control apparatus 300 according to the embodiments in FIGS. 3 and 4, this region can correspond to performing the calculation of Formula 7 and creating the annealing condition reflecting the result in processing S414, and to transmitting the annealing condition to the annealing machine and storing the annealing condition in the annealing condition storage memory 632 in processing S416. Specifically, the loop processing of processing S6000 is executed by skipping a and λ in a specific range by the annealing condition. Alternatively, although a or λ of the specific range is executed, the loop processing of processing S6000 is executed by changing the annealing condition.

### Seventh Embodiment

In each of the embodiments described above, setting of a preferable number of bits of a coefficient, which can obtain a highly accurate result, will be described.

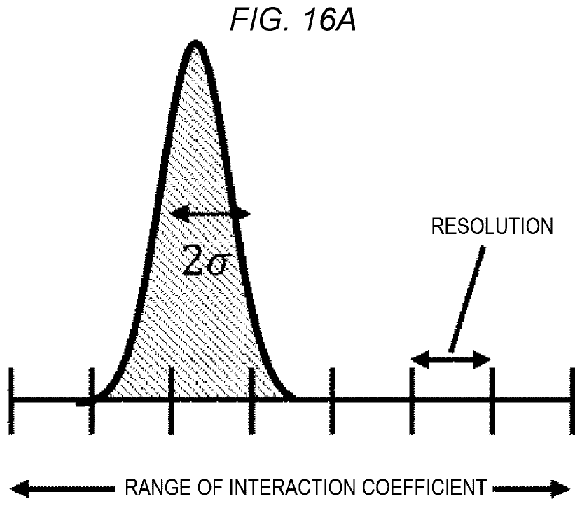

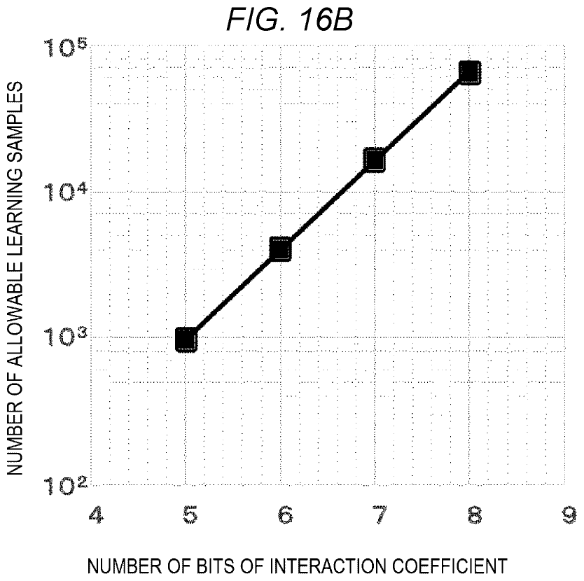

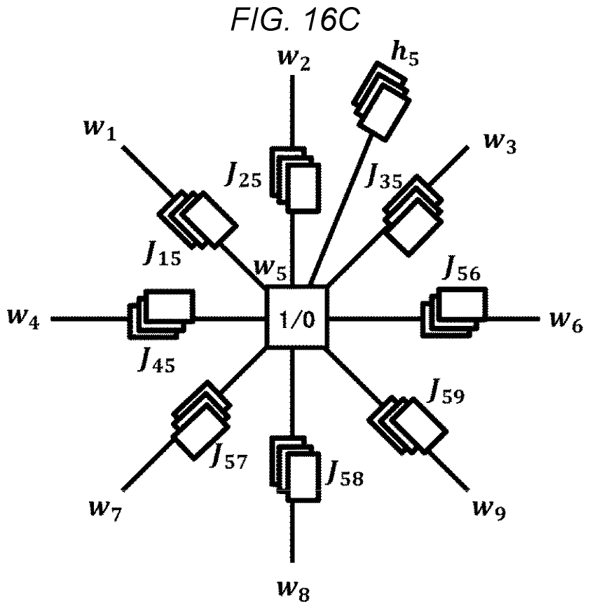

FIG. 16A is a graph showing a distribution of interaction coefficient jᵢⱼ representing classifier correlation. Although discretization of jᵢⱼ proceeds as the number of learning samples increases, it is desirable that a resolution of the interaction coefficient is at least on the same order as a range covering variation (2σ), that is, 95%, so as to prevent accuracy deterioration associated with the discretization.

FIG. 16B is a graph showing the number of bits of the interaction coefficient jᵢⱼ on a horizontal axis and the number of allowable learning samples on a vertical axis based on the above idea. Although increasing the number of learning samples is preferable in learning weak classifiers, the number of bits of necessary interaction coefficient also increases exponentially. For example, assuming that the number of samples is about 20000, the number of bits of the necessary interaction coefficient jᵢⱼ is 7 bits.

FIG. 16C is a schematic diagram showing a relationship between the interaction coefficient jᵢⱼ and an external magnetic field coefficient hᵢ for a certain spin. For the spin of a central index 5, eight spins of indices 1 to 4 and 6 to 9 become adjacent spins. In this diagram, a value of the spin is converted to a weight w of the weak classifier, and w takes a value of 1 or 0. Here, the value of the external magnetic field hᵢ needs to be larger than a sum of surrounding interaction coefficients so as to always enable a calculation with the interaction coefficient. Therefore, in addition to the number of bits of the interaction coefficient, the number of bits corresponding to the number of edges (in this case, the number of edges 8=3 bits) is further necessary. That is, assuming that the number of samples is about 10⁴ to 10⁵, the number of bits of necessary interaction coefficient is 7+3=10 bits. Therefore, the number of bits of a memory cell storing the coefficient is set in consideration of these.

The invention is not limited to the embodiments described above, and includes various modifications. For example, a part of a configuration of a certain embodiment may be replaced with a configuration of other embodiments, and the configuration of the other embodiments may be added to the configuration of the certain embodiment. In addition, a part of the configuration of each embodiment may be added, deleted, or replaced with other configurations in embodiment.

What is claimed is:

1. An information processing apparatus that comprises an annealing calculation circuit including a plurality of spin units and that obtains a solution using an Ising model, wherein
each of the plurality of spin units includes:
a first memory cell that stores a value of the spin of the Ising model;
a second memory cell that stores an interaction coefficient with an adjacent spin that interacts with the spins;
a third memory cell that stores an external magnetic field coefficient of the spin; and
an operational circuit that performs an operation of determining a next value of the spin based on a value of the adjacent spin, the interaction coefficient, and the external magnetic field coefficient,
the information processing apparatus further comprises an external magnetic field coefficient update circuit that updates the external magnetic field coefficient with a monotonic increase or a monotonic decrease, and
the annealing calculation circuit performs the annealing calculation a plurality of times by the operational circuit based on the updated external magnetic field coefficient.

2. The information processing apparatus according to claim 1, wherein
the external magnetic field coefficient update circuit sets a spin index to i and updates an external magnetic field coefficient hᵢ by changing a parameter λ(l) by changing a variable l based on a formula hᵢ=a(xᵢ−λ(l)).

3. The information processing apparatus according to claim 1, wherein
the external magnetic field coefficient update circuit sets a spin index to i and updates an external magnetic field coefficient hᵢ by changing a parameter a(k) and a parameter λ(l) by changing a variable k and a variable l based on a formula hᵢ=a(k)(xᵢ−λ(l)).

4. The information processing apparatus according to claim 3, comprising:
a loop condition storage memory and a coefficient storage memory, wherein
the loop condition storage memory stores data of the parameter a(k) and the parameter λ(l), and
the coefficient storage memory stores data of the coefficient xᵢ.

5. The information processing apparatus according to claim 3, wherein
the external magnetic field coefficient update circuit includes:
an external magnetic field coefficient calculation circuit that calculates hᵢ=a(k)(xᵢ−λ(l)) by floating-point operation,
a clip circuit that limits a value range of calculated hᵢ,
a constant multiplication circuit that multiplies an output of the clip circuit by a constant, and
a type conversion circuit that converts the output of the constant multiplication circuit into integer type data.

6. The information processing apparatus according to claim 1, comprising:
a verification error calculation circuit, wherein
the annealing calculation circuit obtains a value of the spin when an energy state of an Ising model becomes a local minimum value or a minimum value as a solution by the annealing calculation,
the verification error calculation circuit calculates a verification error based on the solution and the verification data, and
the annealing calculation circuit performs a next annealing calculation to obtain a next solution after the external magnetic field coefficient update circuit updates the external magnetic field coefficient after operating the verification error.

7. The information processing apparatus according to claim 6, comprising:
a classification result storage memory, wherein
the classification result storage memory stores a classification result Δmᵢ(v) corresponding to the index i of the spin for each index v of the verification data, and
the verification error calculation circuit performs calculation based on the solution and the classification result Δmᵢ(v).

8. The information processing apparatus according to claim 6, comprising:
a spin value verification error storage memory, wherein
the spin value verification error storage memory stores the value of the verification error when the verification error is minimum and the value of the spin among the results of the plurality of times of operations by the operational circuit.

9. The information processing apparatus according to claim 8, wherein
after the value of the verification error when the verification error is the minimum and the value of the spin in the spin value verification error storage memory are stored, the annealing calculation circuit updates contents of the first memory cell, the second memory cell, and the third memory cell, and performs a plurality of times of operations by the operational circuit again based on the external magnetic field coefficient updated by the external magnetic field coefficient update circuit.

10. The information processing apparatus according to claim 1, wherein
as a result of the update of the external magnetic field coefficient, the annealing calculation is not performed on a spin unit in which a value of its self-spin is fixed regardless of the value of the adjacent spin.

11. The information processing apparatus according to claim 1, wherein
the number of bits of the second memory cell and the third memory cell is set such that the value of the external magnetic field coefficient is larger than a sum of the interaction coefficients.

12. An information processing method, using an information processing apparatus, which is a host apparatus, and an annealing machine which performs annealing calculation using an Ising model to obtain a solution, the information processing method comprising:
in the information processing apparatus,
generating a weak classifier,
obtaining a classification result of the weak classifier by verification data,
converting a selection problem of the weak classifier when constituting a strong classifier by the weak classifier into an Ising model suitable for hardware of the annealing machine and sending the selection problem to the annealing machine,
in the annealing machine,
storing an external magnetic field coefficient and an interaction coefficient, which are parameters of the Ising model, in the memory cell respectively, and
when the annealing calculation is performed a plurality of times, updating the external magnetic field coefficient with a monotonic increase or a monotonic decrease and then executing each annealing calculation.

13. The information processing method according to claim 12, wherein
the Ising model sent from the host apparatus to the annealing machine is Jᵢⱼ corresponding to an edge of the Ising model and a parameter xᵢ represented by following formula:
$${x}_{i} = {\sum }_{t ∈ T} {c}_{i} ( t ) y ( t ) - \frac{1}{2} {\sum }_{j , t ∈ T} {c}_{i} ( t ) {c}_{j} ( t )$$
in the formula, i is an index of the weak classifier, T is a set of training data for the weak classifier, t is an index of training data, cᵢ (t) is a classification result of the training data of index t by the weak classifier of index i, and y(t) is a correct classification of the training data at index t,
parameters stored in the memory cell are the Jᵢⱼ representing the interaction coefficient and hᵢ=a(xᵢ−λ(l)) representing the external magnetic field coefficient, and
hᵢ representing the external magnetic field coefficient is calculated and updated by changing the value of λ(l).

14. The information processing method according to claim 13, wherein
a=a(k) is satisfied, and hᵢ representing the external magnetic field coefficient is updated by independently changing the value of a(k) and the value of λ(l).

15. The information processing method according to claim 12, wherein
a part of the edges of an original model is lost when converting to the Ising model suitable for the hardware of the annealing machine.
